(19) United States
(12) Patent Application Publication
(10) Pub. No.: US 2010/0243747 A1
(43) Pub. Date: Sep. 30, 2010

(54) INFORMATION CODE

(76) Inventor: Takahiro Saito, Tokushima (JP)

Correspondence Address: J C PATENTS, 4 VENTURE, SUITE 250, IRVINE, CA, 92618, US

(21) Appl. No.: 12/739,041

(22) PCT Filed: Oct. 21, 2008
(86) PCT No.: PCT/JP2008/069008

§ 371 Date: Apr. 21, 2010

(30) Foreign Application Priority Data
Oct. 25, 2007 (JP) 2007-277651
Apr. 8, 2008 (JP) 2008-100534

(51) Int. Cl. G06K 19/06

(52) U.S. Cl. 235/494

(57) ABSTRACT

One information code unit is configured by a first module and a second module which are “red,” a third module which is “black,” a fourth module and a fifth module which are “white,” and a sixth module and a seventh module which are “black.” When the information code is read by first reading means such as a barcode reader, white or black binarization determination is performed. As a result, the code is recognized as “white, black, white, black,” as in the read result of a conventional monochromatic barcode. On the other hand, when the information code is read by second reading means such as a mobile phone camera, the “black” regions can be read as “black” and the “white” regions as “white,” while the “red” region can be differentiated from the “black” and the “white” regions. Thus, the information code can be utilized as a multi-signal information code.

### TECHNICAL FIELD

The present invention relates to a color gradation information code which represents information on a subject such as a product and from which the information is optically read.

### BACKGROUND ART

In a conventional POS (Point Of Sales) system or an inventory management system, there has been widely utilized a reading device that reads a barcode, which is information display means for displaying product information on the product, as well as information displayed by the barcode. This reading device is characterized in being capable of simply printing the barcode and using light as a detecting medium to easily read the information displayed by the barcode.

There are barcodes such as JAN (Japanese Article Number: also called GS1), ITF, CODE=138, CODE=39 and NW-7, and each of these barcodes has its own unique display style. Among these barcodes, in the JAN code, which is widely used, as set forth in JIS-X0501 two black bars and two spaces (two white bars) are formed in units of seven modules, and the two black bars and the two spaces represent one numeral, wherein the narrowest bar is defined as one module. Here, the thinnest bar or space out of these formed bars has width equivalent to one module, while the thickest black bar or space has width equivalent to four modules. Various numerals are represented by varying the thickness of the black bars and spaces and the arrangements thereof.

The JAN code also has a display style for representing thirteen-digit numerals by lining up thirteen units each comprising seven modules. The first two digits of the thirteen numerals represents a country code, the next five digits a manufacturer, and the subsequent five digits the type of the product. The last one digit is used for recalculation.

However, the JAN code has only five digits of numerals to represent the type of the product, and five-digit numerals are not enough to represent a sufficient number of products, as the variety increases and the number of products decreases. Hence, in order to register new products, the registration of the products that are no longer handled needs to be canceled.

In view of such circumstances, the applicant of the present invention proposes an information code in which, according to Patent Document 1, at least three types of display regions with different reflection or radiation wavelength characteristics are formed in an aligned manner, and which has an information element displaying a combination of wavelength characteristics of the aligned display regions, and a reading device which optically reads information displayed by the information code.

Incidentally, the barcode described above is optically read by a barcode reader of a POS terminal disposed in a cash register in a supermarket, convenience store, or the like. Most of these barcode readers are for performing white or black binarization determination on reflected light by using a single-color light source such as a red LED or LD, to read the barcode information.

Patent Document 1: Japanese Patent Application Publication No. H11-161757

### DISCLOSURE OF THE INVENTION

An object of the present invention is to provided a color gradation information code, which is capable of being distributed without modifying an existing general system, such as a POS system, and is also capable of reading different information, and increasing the amount of information, when using an optical reading device that has a different reading system from the general system.

A color gradation information code according to one aspect of the present invention is an information code that corresponds to first reading means for performing white or black binarization determination on reflected light and reading region information, and to second reading means for identifying color information of the reflected light and reading the region information, the information code including: a first display region that is determined to be black or white by both the first reading means and the second reading means, and a second display region that is determined to be white or black by the first reading means and identified as the color information by the second reading means.

A color gradation information code according to a another aspect of the present invention is an information code that corresponds to first reading means for performing white or black binarization on reflected light and reading region information, and second reading means for identifying color information of the reflected light and reading the region information, the color gradation information code including: a first information layer, which is configured by a white-designated region and black-designated region and information of which is read by the first reading means; and a second information layer, which is configured by a first color region that is written over the white-designated region and that is determined to be white by the first reading means, and identified as first color information by the second reading means, and a second color region that is written over the black-designated region, determined to be black by the first reading means and that is identified as second color information by the second reading means, information in the second information layer being read by the second reading means.

The object, characteristics and advantages of the present invention will be understood with reference to the following detailed description and the accompanying drawings.

### BRIEF DESCRIPTION OF THE DRAWINGS

FIG. 1A is a perspective view showing a state in which an information code is read optically by first reading device; FIG. 1B is a perspective view showing a state in which the information code is read optically by second reading device.

FIG. 2A is a schematic diagram of an information code 10A according to a first embodiment of the present invention; FIG. 2B is a graph showing reflected light levels; FIG. 2C is a tabular form diagram showing a read result of each module.

FIG. 3 is a tabular form diagram showing module patterns of one unit that can be obtained in the first embodiment.

FIG. 4A is a schematic diagram of an information code 10B according to a second embodiment of the present invention; FIG. 4B is a graph showing reflected light levels; FIG. 4C is a tabular form diagram showing a read result of each module.

FIG. 5 is a tabular form diagram showing module patterns of one unit that can be obtained in the second embodiment.

FIG. 6A is a schematic diagram of an information code 10C according to a third embodiment of the present invention; FIG. 6B is a graph showing reflected light levels; FIG. 6C is a tabular form diagram showing a read result of each module.

FIG. 7A is a schematic diagram of an information code 10D according to a fourth embodiment of the present invention; FIG. 7B is a tabular form diagram showing coloring examples of color modules R1 to R4.

FIG. 8 is a schematic diagram of an information code 10E according to a fifth embodiment of the present invention.

FIGS. 9A to 9D are schematic diagrams of an information code 100A according to a sixth embodiment of the present invention, wherein FIGS. 9A to 9C are schematic diagrams each showing a configuration of information layers of the information code 100A, and FIG. 9D a diagram showing an appearance of the information code in which these information layers are described in a stacked manner.

FIG. 10A and FIG. 10B are schematic diagrams showing an example of a read result of the information code 100A.

FIGS. 11A to 11D are schematic diagrams of an information code 100B according to a seventh embodiment of the present invention, wherein FIGS. 11A to 11C are schematic diagrams each showing a configuration of information layers of the information code 100B, and FIG. 11D a diagram showing an appearance of the information code in which these information layers are described in a stacked manner.

FIG. 12A and FIG. 12B are schematic diagrams showing an example of a read result of the information code 100B.

FIG. 13 is a planar view showing a more specific example (one-dimensional code type) of the information code to which the present invention is applied.

FIG. 14 is a planar view showing a more specific example (two-dimensional code type) of the information code to which the present invention is applied.

FIG. 15 is a planar view showing a more specific example (combination of the one-dimensional code and the two-dimensional code) of an information code to which the present invention is applied.

### BEST MODE FOR CARRYING OUT THE INVENTION

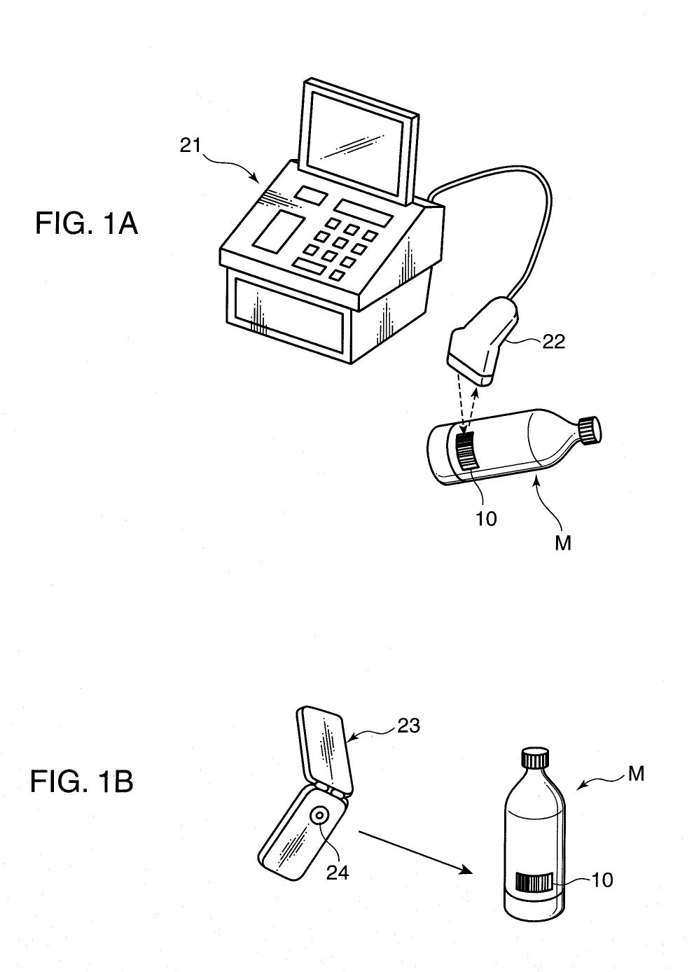

Embodiments of the color gradation information code according to the present invention are now described with reference to the drawings. FIGS. 1A and 1B are perspective views showing a read mode of an information code 10 according to an embodiment of the present invention, which is attached to an object M. FIG. 1A shows a state in which the information code 10 is optically read by a first reading device 22 (first reading means) configured by a barcode reader or the like that is additionally provided to a POS terminal 21 disposed in a cash register in a supermarket, convenience store, or the like. FIG. 1B shows a state in which the information code 10 is optically read by a second reading device 24 (second reading means) configured by a camera device or the like installed in a mobile phone 23.

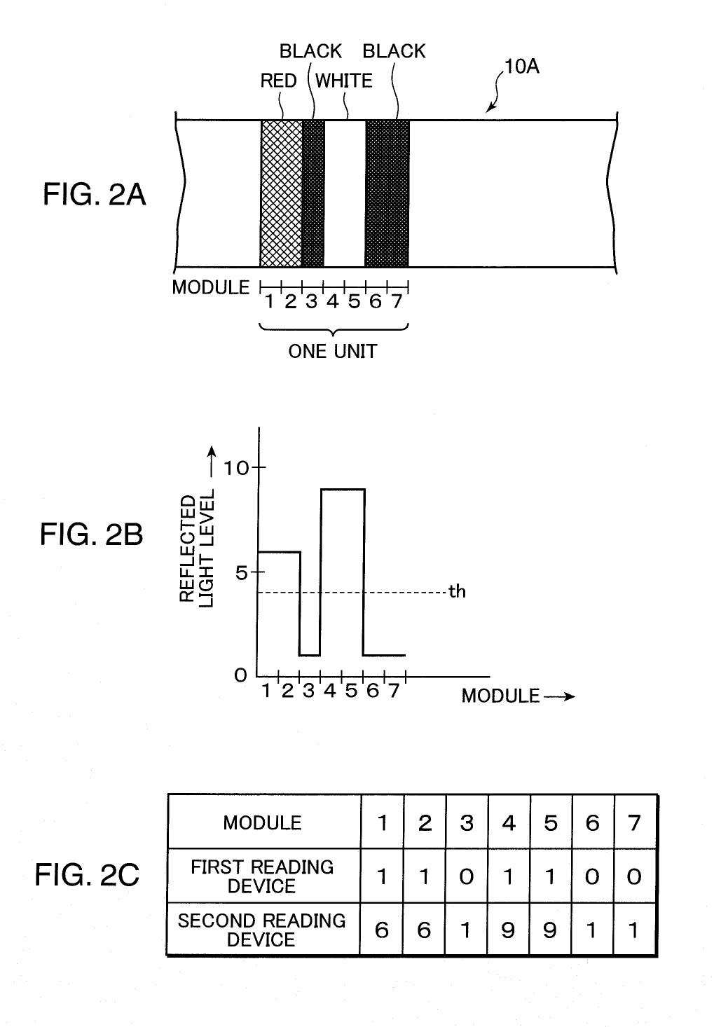

The information code 10 is a barcode composed of bars and spaces, to which, for example, the abovementioned JAN code is formally applied. However, the information code 10 according to the present embodiment has a bar or a space (first display region) that is determined to be black or white by both the first reading device 22 and the second reading device 24, and a bar or a space (second display region) that is determined to be black or white by the first reading device 22 and identified as color information by the second reading device 24. This information code 10 is described later in detail with reference to FIG. 2 and the subsequent drawings.

The first reading device 22 includes a red LED (Light Emitting Diode) emitting visible red light having an emission wavelength of approximately 650 nm, a one-dimensional CCD (Charge Coupled Device) sensor unit in which approximately two thousand CCD elements are arranged in series, and an arithmetic processing unit. When the red light emitted from the red LED irradiates the information code 10, the red light is absorbed by a part or the most of the bars of the information code 10 and at the same time reflected by the spaces. The reflected light having such contrast is received by the CCD sensor unit. The received-light data on the light received by the CCD sensor unit is digitally converted and then subjected to a predetermined data process by the arithmetic processing unit.

The data process includes a process for performing binarization determination based on the intensity of the received-light data for each light-receiving region and reading black (bars) and white (spaces) by using a predefined threshold value. Specifically, although the information code 10 is a barcode containing the color information, the first reading device 22 recognizes the information code 10 as a monochrome barcode. Therefore, the relationship between the first reading device 22 and the information code 10 is same as that in a general POS system.

The second reading device 24 has a two-dimensional color area sensor configured by CCD elements or CMOS (Complementary Metal-Oxide Semiconductor) elements arranged two-dimensionally, and an image processor that processes image data acquired by the sensor. The color area sensor renders the information code 10 as a two-dimensional color image. The image processor performs an edge extraction process or a luminance analyzing process on data of the color image to identify an arrangement mode of the bars and spaces of the information code 10 and the color information (hue, brightness, saturation, etc.) of the same. Therefore, the second reading device 24 can read not only the color information of the information code 10, but also information that is different from the information used when recognizing the information code 10 as the monochrome barcode, or more amount of information can be read.

Next, various embodiments of the information code 10 are described based on FIG. 2 and the subsequent drawings.

### First Embodiment

FIG. 2A is a schematic diagram of an information code 10A according to a first embodiment of the present invention. Here, one unit of seven modules configuring the abovementioned JAN code defined by JIS-X0501 is shown. One unit in a conventional barcode is configured by two black bars and two spaces (two white bars) having a width corresponding to one to four modules, but this embodiment shows an example in which one unit is configured by “red” first and second modules (a fifth display region), a “black” third module (a third display region), “white” fourth and fifth modules (a fourth display region), and “black” sixth and seventh modules (the third display region).

FIG. 2B is a graph showing reflected light levels that are obtained when one unit of the information code 10A is read by the first reading device 22 (barcode reader). As shown in the graph, light emitted from the red LED is absorbed by the third, sixth and seventh modules corresponding to the “black” region. Thus, the CCD elements located in the positions corresponding to these modules receive almost no reflected light, lowering the reflected light level. On the other hand, the light is reflected by the fourth and fifth modules corresponding to the “white” region. Thus, the CCD elements located in the positions corresponding to these modules receive a lot of reflected light, increasing the reflected light level.

On the other hand, although not as much as in the “white” region, a certain amount of light is reflected by the first and second modules corresponding to the “red” region, thus the CCD elements located in the positions corresponding to these modules receive the certain amount of reflected light. For this reason, a reflected light level that is significantly higher than that of the “black” region is detected in the first and second modules. Here, when a threshold value th for white or black binarization determination by the first reading device 22 is set at the level shown in FIG. 2B, the first and second modules are determined to be “white,” as the reflected light levels of these modules exceed the threshold value th.

Therefore, although the information code 10A includes the “red” region, the first, second, fourth and fifth modules are white (=1) and the third, sixth and seventh modules are black (=0), as shown in FIG. 2C, as a result of reading performed by the first reading device 22. In other words, the “red” region is read as the “white” region, which is the same result as the conventional result of reading a monochrome barcode.

When, on the other hand, the one unit of the information code 10A is read by the second reading device 24 (camera device), the information code 10A is read as a color image. Thus, not to mention that the “black” region is read as “black” and the “white” region as “white,” the “red” region can be differentiated from the “black” region and the “white” region and read. In FIG. 2C, the reflected light levels (luminance levels) are displayed according to the modules, and, for example, the first and second modules can be recognized as the regions with color information, based on such level difference. Therefore, unlike the case where the information code 10A is read as monochrome information, the information code 10A can be utilized as a multi-signal information code, since the color information is added thereto.

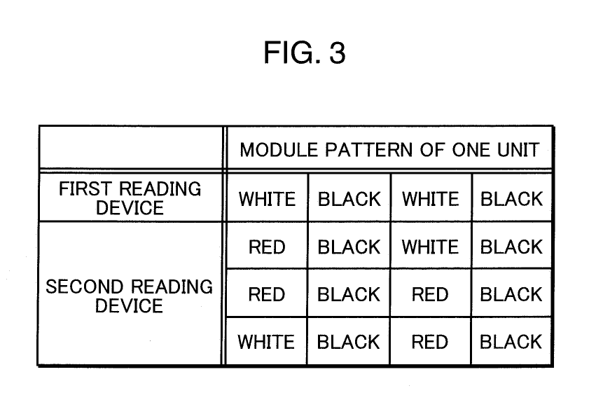

FIG. 3 shows module patterns of one unit that can be obtained in the first embodiment. As shown in FIG. 3, a module pattern that is read by the first reading device 22 as “white, black, white, black” can be constituted as three module patterns of “red, black, white, black” (the pattern shown in FIG. 2A), “red, black, red, black” and “white, black, red, black” that are read by the second reading device 24.

### Second Embodiment

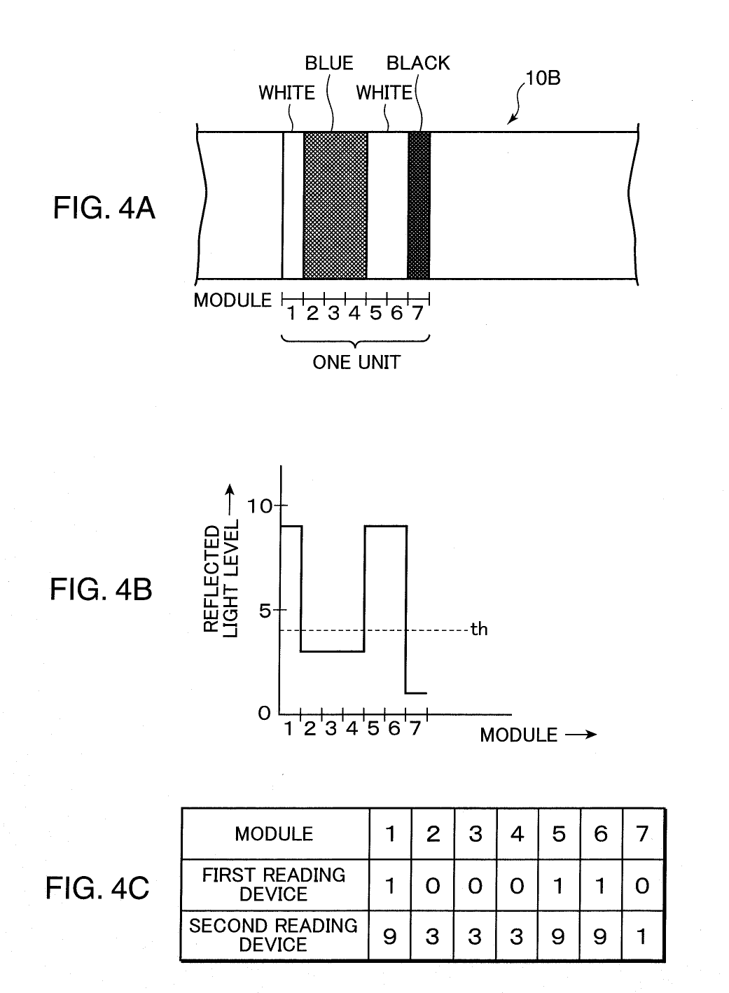

FIG. 4A is a schematic diagram of an information code 10B according to a second embodiment. Here, this embodiment shows an example configured by a “white” first module (a seventh display region), “blue” second to fourth modules (an eighth display region), “white” fifth and sixth modules (the seventh display region), and a “black” seventh module (a sixth display region). The “blue” region is a region where red light absorption is larger than that in the “red” region in the first embodiment.

FIG. 4B is a graph showing reflected light levels that are obtained when the first reading device 22 reads the one unit of the information code 10B. As shown in the graph, the red light is absorbed by the seventh module corresponding to the “black” region. Therefore, the reflected light level of this module is low. On the other hand, the light is reflected by the first, fifth and sixth modules corresponding to the “white” region, increasing the reflected light levels of these modules.

On the other hand, although not as much as in the “black” region, a certain amount of light is reflected by the second to fourth modules corresponding to the “blue” region, thus the CCD elements located in the positions corresponding to these modules receive a low level of reflected light. For this reason, a reflected light level that is significantly lower than that of the “white” region is detected in the second to fourth modules. Here, when the threshold value th for white or black binarization determination by the first reading device 22 is set at the level shown in FIG. 4B, the second to fourth modules are determined to be “black,” as the reflected light levels of these modules fall below the threshold value th.

Therefore, although the information code 10B includes the “blue” region, the first, fifth and sixth modules are white (=1) and the second, third, fourth and seventh modules are black (=0), as shown in FIG. 4C, as a result of reading performed by the first reading device 22. In other words, the “blue” region is read as the “black” region, which is the same result as the conventional result of reading a monochrome barcode.

When, on the other hand, the one unit of the information code 10B is read by the second reading device 24, the information code 10B is read as a color image. Thus, the “black” region is read as “black” and the “white” region as “white,” and the “blue” region can be differentiated from the “black” and “white” regions and read. In FIG. 4C, the reflected light levels (luminance levels) are displayed according to the modules, and, for example, the second to fourth modules can be recognized as the regions with color information, based on such level difference. Therefore, unlike the case where the information code 10B is read as monochrome information, the information code 10B can be utilized as a multi-signal information code, since the color information is added thereto.

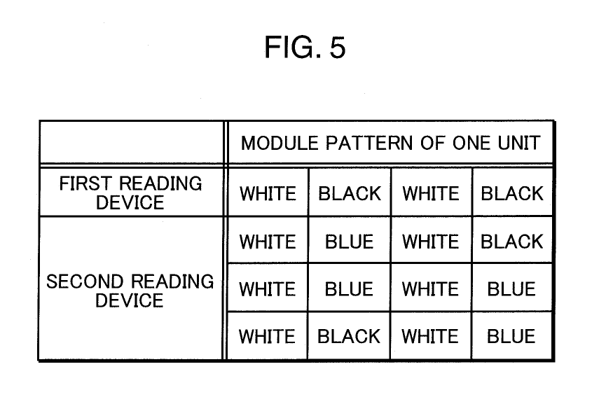

FIG. 5 shows module patterns of one unit that can be obtained in the second embodiment. As shown in FIG. 5, a module pattern that is read by the first reading device 22 as “white, black, white, black” can be constituted as three module patterns of “white, blue, white, black” (the pattern shown in FIG. 4A), “white, blue, white, blue” and “white, black, white, blue” that are read by the second reading device 24.

### Third Embodiment

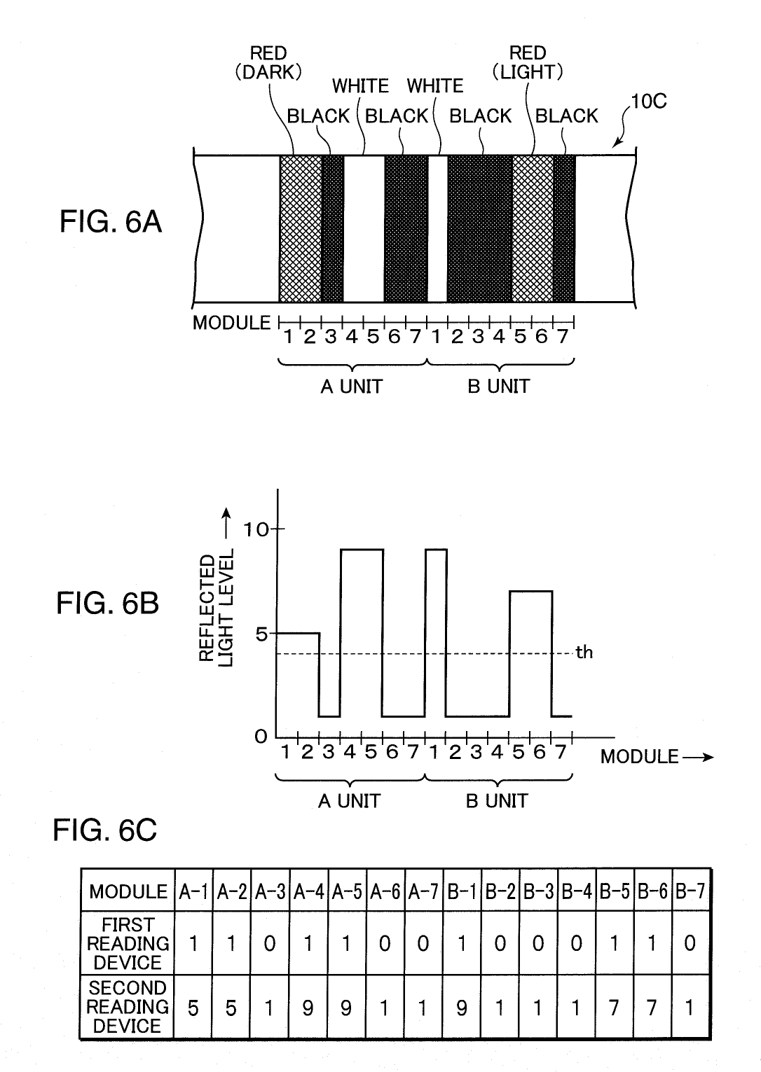

FIG. 6A is a schematic diagram of an information code 10C according to a third embodiment. Here, two units of an A unit and B unit each configured by seven modules are shown. This embodiment shows an example in which the A unit is configured by “red (dark)” first and second modules, a “black” third module, “white” fourth and fifth modules, and “black” sixth and seventh modules. This embodiment also shows an example in which the B unit is configured by a “white” first module, “black” second to fourth modules, “red (light)” fifth and sixth modules, and a “black” seventh modules. The difference between the information code 10C according to the third embodiment and the information code 10A of the first embodiment described above is that the information code 10C has a module that has different density (brightness and/or saturation) of the same hue (red).

FIG. 6B is a graph showing reflected light levels that are obtained when the first reading device 22 reads the A unit and the B unit of the information code 10C. As shown in the graph, the red light is absorbed by the third, sixth and seventh modules corresponding to the “black” region in the A unit. Therefore, the reflected light levels of these modules are low. On the other hand, the light is reflected by the fourth and fifth modules corresponding to the “white” region, increasing the reflected light levels of these modules. Because a certain amount of light is reflected by the first and second modules corresponding to the “red (dark)” region, a reflected light level corresponding to that certain amount of reflected light is detected. In the B unit, on the other hand, the reflected light levels of the second to fourth modules and the seventh module corresponding to the “black” region are low, and the reflected light level of the first module corresponding to the “white” region is high. Because a certain amount of light is reflected by the fifth and sixth modules corresponding to the “red (light)” region, a reflected light level corresponding to that certain amount of reflected light is detected. However, the lower the density is than that of the “red (dark)” region, the higher the reflected light level is detected.

When the threshold value th for white or black binarization determination by the first reading device 22 is set at the level shown in FIG. 6B, the first and second modules corresponding to the “red (dark)” region of the A unit and the fifth and sixth modules corresponding to the “red (light)” region of the B unit are recognized as “white,” as the reflected light levels of these modules exceed the threshold value th.

Therefore, although the information code 10C includes the “red” regions having different densities, in the A unit the first, second, fourth and fifth modules are white (=1) and the third, sixth and seventh modules are black (=0), as shown in FIG. 6C, as a result of reading performed by the first reading device 22. In the B unit, the first, fifth and sixth modules are white (=1) and the second to fourth and seventh modules are black (=0). In other words, the “red (dark)” and “red (light)” regions are read as the “white” region, which is the same result as the conventional result of reading a monochrome barcode.

On the other hand, when the A unit and the B unit of the information code 10C are read by the second reading device 24, the information code 10C is read as a color image. Thus, the “black” region is read as “black” and the “white” region as “white,” and the “red (dark)” and “red (light)” regions can be differentiated and read. In FIG. 6C, the reflected light levels (luminance levels) are displayed according to the modules, and, for example, the first and second modules of the A unit and the fifth and sixth modules of the B unit can be recognized as the regions with color information, based on such level difference. In addition, the difference between the “red (dark)” region and the “red (light)” region can be read. Therefore, unlike the case where the information code 10C is read as monochrome information, the information code 10C can be further utilized as a multi-signal information code, since the color information and color tone information are added thereto.

### Fourth Embodiment

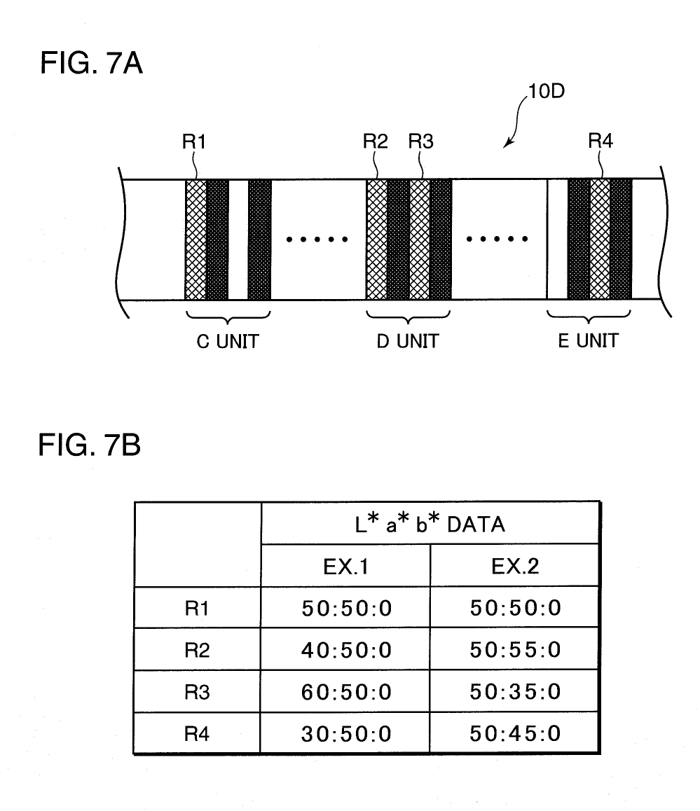

FIG. 7A is a schematic diagram of an information code 10D according to a fourth embodiment. The third embodiment has illustrated two tones of dark red and light red, but more types of color tones may be included in order to increase the amount of information. The information code 10D is an example of an information code that includes such multiple tone color information.

The information code 10D includes a C unit, D unit and E unit each configured by seven modules. Each of these units includes not only the black modules and white modules but also color modules R1 to R4 that have different brightness and/or saturation of the same or similar hue. These color modules R1 to R4 are recognized as different colors when the information code 10D is read by the second reading device 24.

FIG. 7B is a tabular form diagram showing coloring examples of the color modules R1 to R4. Here, the colors of the color modules R1 to R4 are expressed by chromaticity data represented by a L*a*b* color system suggested by International Commission on Illumination (CIE). EX. 1 of FIG. 7B shows an example in which the chromaticity (a*, b*) showing the hue and saturation is obtained as a fixed (red) chromaticity and the brightness L* of each of the color modules R1 to R4 is changed. EX. 2 shows an example in which the brightness L* is fixed but a* is changed so that the hue and the saturation are changed. These merely examples, and therefore various modes for imparting gradations to the colors can be applied.

When the information code 10D is read by the first reading device 22, each of the color modules R1 to R4 has a reflectance at which each of the color modules R1 to R4 is recognized as “white.” Therefore, when the information code 10D is read by the first reading device 22, all of the C, D and E units are read as a “white, black, white, black” module pattern, which is the same result as the conventional result of reading a monochrome barcode. On the other hand, when the information code 10D is read by the second reading device 24, the color modules R1 to R4 are recognized as different colors, as described above. Therefore, the information code 10D can be further utilized as a multi-signal information code.

### Fifth Embodiment

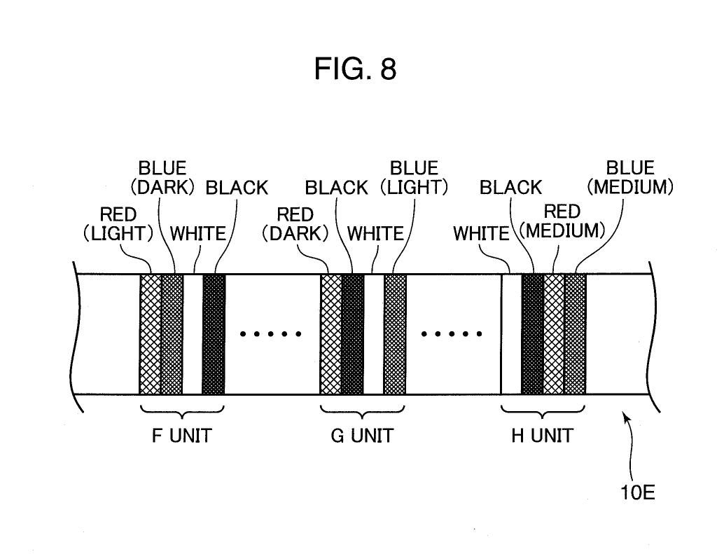

FIG. 8 is a schematic diagram showing an information code 10E according to a fifth embodiment. This information code 10E is an information code that includes color modules having different hues and has a density gradation set for each color.

The information code 10E includes an F unit, G unit and H unit each configured by seven modules. Each of these units includes not only the black modules and white modules but also a red (dark, medium, light) module and blue (dark, medium, light) module. Specifically, the F unit has a module pattern of “red (light), blue (dark), white, black”, the G unit has a module pattern of “red (dark), black, white, blue (light)”, and the H unit has a module pattern of “white, black, red (medium), blue (medium)”.

Here, when the information code 10E is read by the first reading device 22, the red (dark, medium, light) module has a reflectance at which this module is recognized as “white,” and the blue (dark, medium, light) module has a reflectance at which this module is recognized as “black.” Therefore, when the information code 10E is read by the first reading device 22, all of the F, G and H units are read as a “white, black, white, black” module pattern, which is the same result as the conventional result of reading a monochrome barcode. On the other hand, when the information code 10E is read by the second reading device 24, the “red” and “blue” are recognized separately, and the densities (dark, medium, light) thereof can be recognized. Therefore, the information code 10E can be further utilized as a multi-signal information code.

### Sixth Embodiment

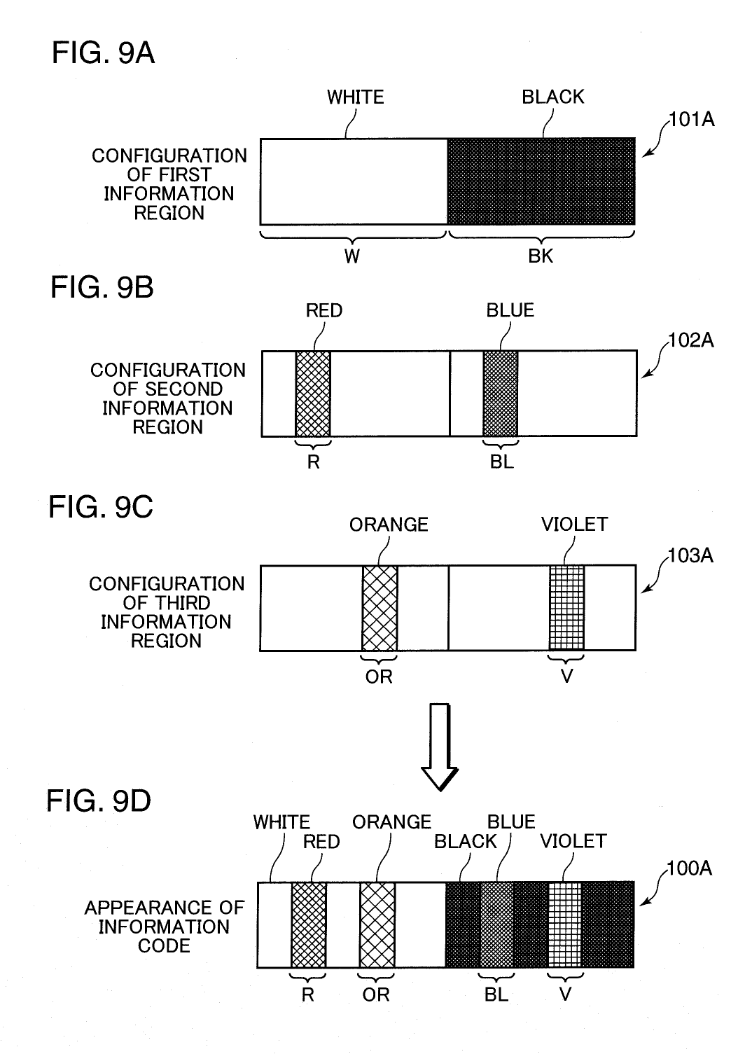

Next, an embodiment focusing on a description method of an information code is described. FIG. 9D is a schematic diagram of an information code 100A according to a sixth embodiment. FIGS. 9A to 9C are schematic diagrams each showing a configuration of information layers of the information code 100A. This embodiment shows an example in which the information code 100A has three regions of a first information region 101A, second information region 102A and third information region 103A. The first information region 101A is a monochrome barcode layer (first information layer) that is read as monochrome information, and the second and third information regions 102A and 103A are color barcode layers (second information layers) that are read as color information.

As shown in FIG. 9A, the first information region 101A is configured by a white-designated region W and black-designated region BK. Because the first information region 101A is a monochrome information layer, the white-designated region W is described as “white” and the black-designated region BK as “black.” Furthermore, the described information of the first information layer 101A are read by the first reading device 22.

As shown in FIG. 9B, the second information region 102A is an information region described with “red” (first color information) and “blue” (second color information). “Red” is described on a red-designated region R (first color region) set on the white-designated region W. “Blue” is described on a blue-designated region BL (second color region) set on the black-designated region BK. In other words, “red” is written over “white,” and “blue” is written over “black.” As with the embodiments described above, “red” is determined to be “white” by the first reading device 22 but is identified as the color information called “red” by the second reading device 24. Moreover, “blue” is determined to be “black” by the first reading device 22 but is identified as the color information called “blue” by the second reading device 24.

In addition, as shown in FIG. 9C, the third information region 103A is an information layer described with “orange” (third color information) and “violet” (fourth color information). “Orange” is described on an orange-designated region OR (third color region) set on the white-designated region W. “Violet” is described on a violet-designated region V (fourth color region) set on the black-designated region BK. More specifically, “orange” is provided over “white” and “violet” is provided over “black”. In other words, “orange” is determined to be “white” by the first reading device 22 but is identified as the color information called “orange” by the second reading device 24. Moreover, “violet” is determined to be “black” by the first reading device 22 but is identified as the color information called “violet” by the second reading device 24.

FIG. 9D is an appearance of the information code 100A in which the first information layer (first information region 101A) and second information layers (second information region 102A and third information region 103A) are described in a stacked manner. In this information code 100A, the “red,” “orange,” “blue” and “violet” color bars of the color barcode layers (second information region 102A and third information region 103A) that are written over the monochrome barcode layer (first information region 101A) configured by “white” and “black” are planned to be handled as continuous signals in a signal process by being read by the second reading device 24, and subjected to a decimalization process. Therefore, the red-designated region R and the orange-designated region OR are disposed so as not to substantially overlap on each other in the white-designated region W. Furthermore, the blue-designated region BL and the violet-designated region V are disposed so as not to substantially overlap on each other in the black-designated region BK.

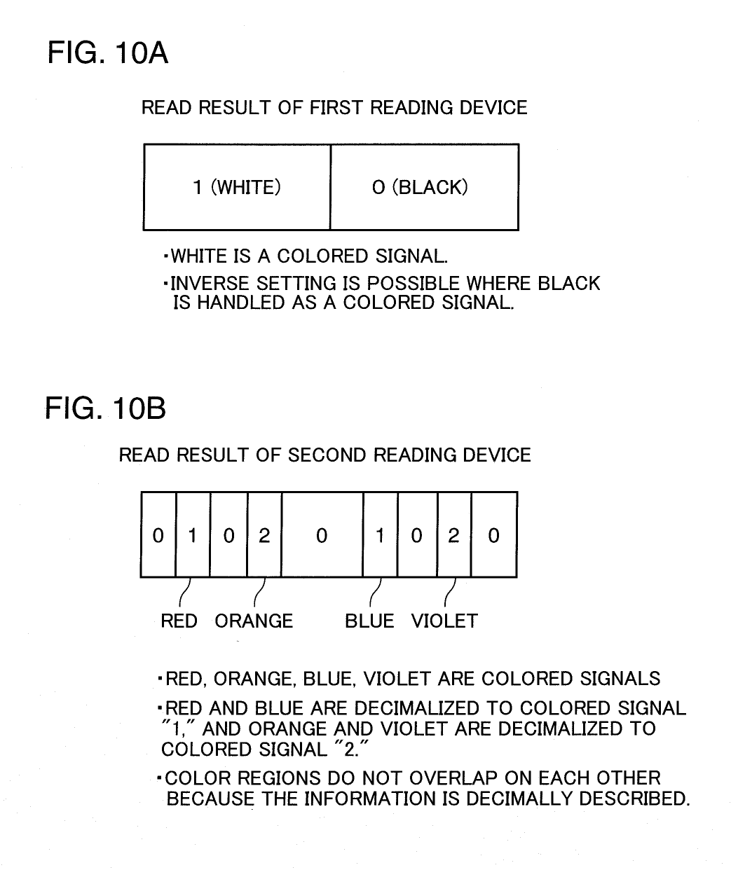

FIGS. 10A and 10B are schematic diagrams showing an example of a read result of the information code 100A. As shown in FIG. 10A, when the information code 100A is read by the first reading device 22, information possessed by the monochrome barcode of the first information region 101A is acquired. For example, the information in which “white”=1 and “black”=0 or, conversely, “white”=0 and “black”=1 is read. The color barcode layers do not have any impacts in this reading process.

As shown in FIG. 10B, on the other hand, when the information code 100A is read by the second reading device 24, each of the color bars of the color barcode layers is read as a colored signal. In other words, “red” and “blue” of the second information region 102A represent colored signals “1,” and “orange” and “violet” of the third information region 103A represent colored signals “2.” If a fourth information region, fifth information region and more information regions are overwritten, these color bars represent colored signals “3,” “4,” and the like. The color signals are read decimally in this manner.

Next is described an example of a flow in which the information code 100A with the three information regions of the first information region 101A to the third information region 103A is written.

(1) Creating a monochrome barcode data signal: For example, the following signal is generated to write the first information region 101A.

{0101001 . . . }

(2) Creating a color barcode data signal: For the second information region 102A and the third information region 103A that are written over the first information region 101A, for example, the following signal is generated. In this case, a data signal configured by a ternary number.

{0102001120 . . . }

(3) Data stacking process and color conversion process: In order to superimpose a color barcode on a monochrome barcode, a color conversion matrix shown in Table 1 is applied to perform color conversion, and color data is created. Note that Table 1 shows “white”=0 and “black”=1. The color data to be created is, for example, the following data signal.

{R, BK, W, BL, W, V, OR, BK, R . . . }

(4) The information code 100A in which the information regions are stacked is printed in color based on the color data.

TABLE 1

| Monochrome | | |
|---|---|---|
| barcode layer | Color barcode layer | Converted color |
| 0 | 0 | White (W) |
| 1 | 0 | Black (BK) |
| 0 | 1 | Red (R) |
| 1 | 1 | Blue (BL) |
| 0 | 2 | Orange (OR) |
| 1 | 2 | Violet (V) |

According to the information code 100A obtained by such a description method, the information possessed by the monochrome barcode of the first information region 101A is secured, and then information can be described by the colored signals of the second information region 102A and third information region 103A composed of the color barcodes, by adding decimals. Moreover, by overwriting the fourth information region, the fifth information region and the like using a similar description method, the color barcode layers can further be multi-valued, drastically increasing the amount of information.

### Seventh Embodiment

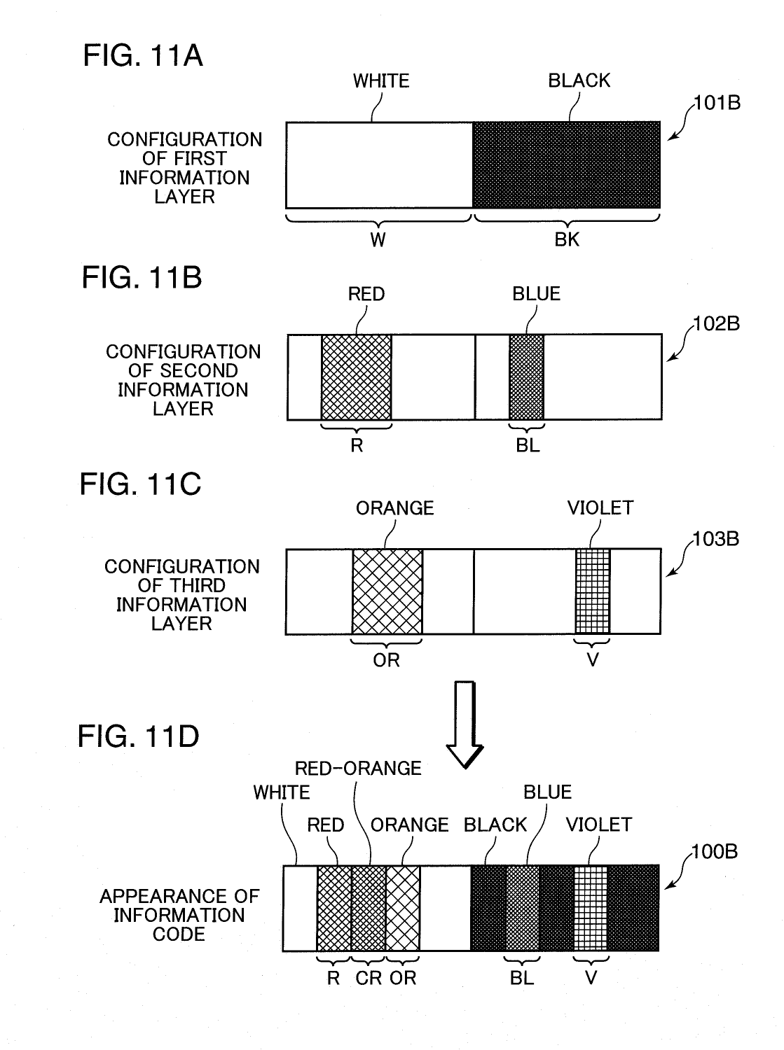

Next is described an example in which, unlike the sixth embodiment, each of the stacked color barcode layers is described independently as an information layer. FIG. 11D is a schematic diagram of an information code 100B according to a seventh embodiment. FIGS. 11A to 11C are schematic diagrams each showing a configuration of information layers of the information code 100B. This embodiment shows an example in which the information code 100B has three information layers of a first information layer 101B, second information layer 102B and third information layer 103B. The first information layer 101B is an information layer that is read as monochrome information, and the second and third information layers 102B and 103B are information layers that are read as color information.

The configurations of the first information layer 101B, second information layer 102B and third information layer 103B shown in FIGS. 11A, 11B and 11C are the same as the configurations of the first information layer 101A, second information layer 102A and third information layer 103A described with reference to FIGS. 9A, 9B and 9C. The difference is that the color bars contained in the second information layer 102B and the third information layer 103B are handled individually as information layers that are independent of one another, instead of as continuous signals.

Because the second information layer 102B and the third information layer 103B are sequentially written as individual information layers over the first information layer 101B, there is a possibility that color regions of the second information layer 102B overlap with color regions of the third information layer 103B. This embodiment illustrates an example in which the information code 100B is set to include a section where a red-designated region R having color information of “red” of the second information layer 102B described therein overlaps with an orange-designated region OR having color information of “orange” of the third information layer 103B described therein.

As a result, the red-designated region R for the color information “red” overlaps with the orange-designated region OR for the color information “orange” in a white-designated region W, as shown in FIG. 11D, a red-orange region CR with color information of “red-orange” is formed by this color overlap. If a blue-designated region BL for color information “blue” overlaps with a violet-designated region V for color information of “violet” in a black-designated region BK, an azure region is formed.

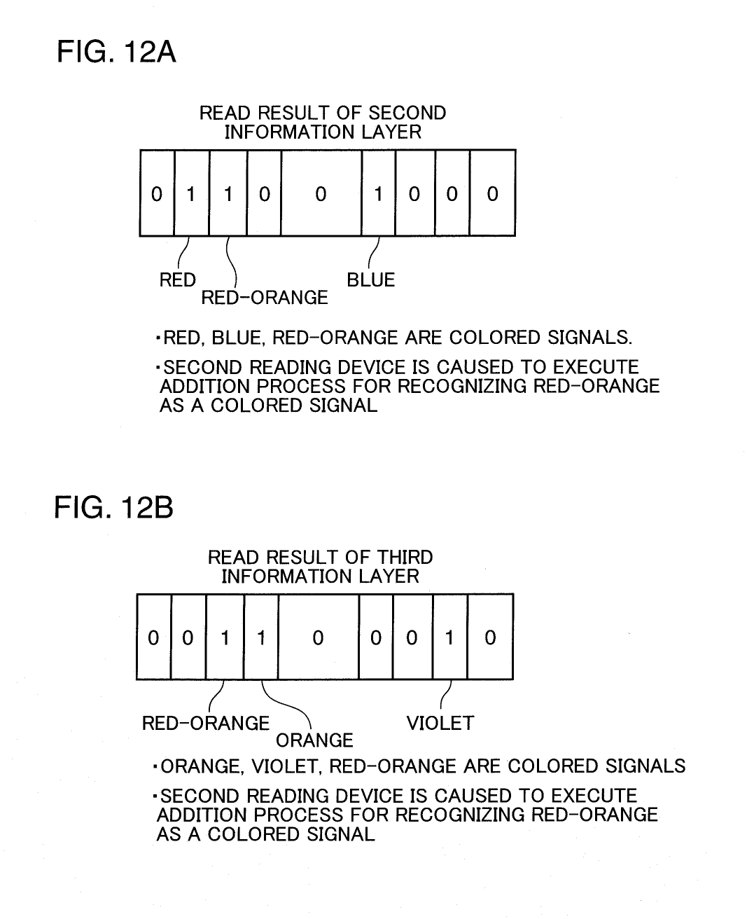

FIGS. 12A and 12B are schematic diagrams showing an example of a read result of the information code 100B. When the information code 100B is read by the first reading device 22, the same read result as that of the sixth embodiment is obtained, thus the description thereof is omitted. FIG. 12A shows a read result that is obtained when the information code 100B is read by the second reading device 24 for the purpose of reading the second information layer 102B. In this case, “red” and “blue” of the second information layer 102B represent a colored signal “1,” and the rest of the regions represents “0.”

Here, the “red-orange” color bar is a region that is generated by an overlap between a region that is originally “red,” and “orange.” Therefore, “red-orange” also represents a colored signal “1.” The second reading device 24 expects to obtain color mixture (“red-orange” in this case) of the color bars contained in the color barcode layers, and, at the time of the signal process, performs setting on an addition process for determining that both “red” and “red-orange” represent the colored signal “1.” Consequently, the information contained in the second information layer 102B can be read accurately.

FIG. 12B shows a read result that is obtained when the information code 100B is read by the second reading device 24 for the purpose of reading the third information layer 103B. In this case, “orange” and “violet” of the third information layer 103B represent a colored signal “1,” and the rest of the regions represents “0.” In this case as well, the “red-orange” color bar is a region that is generated by an overlap between a region that is originally “orange,” and “red” of the second information layer 102B. Thus, “red-orange” also represents the color signal “1.” Consequently, the information contained in the third information layer 103B can be read accurately.

Next is described an example of a flow in which the information code 100B with the three information regions of the first information region 101B to the third information region 103B is written.

(1) Creating a monochrome barcode data signal: For example, the following signal is generated to write the first information region 101B.

{0101001 . . . }

(2) Creating a color barcode data signal: For the second information region 102B and the third information region 103B that are written over the first information region 101B, for example, the following signals are generated. In this embodiment, because the second information layer 102B and the third information layer 103B are individually independent information layers, data signal corresponding thereto respectively are formed.

Second information layer 102B={1011010 . . . }

Third information layer 103B={1100101 . . . }

(3) Data stacking process and color conversion process: In order to superimpose a color barcode on a monochrome barcode, a color conversion matrix shown in Table 2 is applied to perform color conversion, and color data is created. The color data to be created is, for example, the following data signal.

{W, R, CR, OR, W, BK, BL, BK, V, . . . }

(4) The information code 100B in which the information layers are stacked is printed in color based on the color data.

TABLE 2

| First layer | | | |
|---|---|---|---|
| data | Second layer | Third layer | Converted |
| (monochrome) | data (color) | data (color) | color |
| 0 | 0 | 0 | White (W) |
| 1 | 0 | 0 | Black (BK) |
| 0 | 1 | 0 | Red (R) |
| 1 | 1 | 0 | Blue (BL) |
| 0 | 0 | 1 | Orange (OR) |
| 1 | 0 | 1 | Violet (V) |
| 0 | 1 | 1 | Red-orange |
| | | | (CR) |
| 1 | 1 | 1 | Azure (AZ) |

According to the information code 100B obtained by such a description method, the information possessed by the monochrome barcode of the first information region 101B is secured, and then additional information can be described by the second information region 102A and third information region 103A composed of the color barcodes, individually, whereby the amount of information can be increased. The fourth information layer, the fifth information layer and the like can be overwritten by using the description method of the information code 100B. However, this is appropriately performed when the number of information layers to be stacked is approximately 2 to 4, because the signal processing performed on the color mixture part tends to become complicated as the number of layers increases.

The first to seventh embodiments described above can provide an information code that is capable of being distributed without modifying a conventional multi-purpose system using the first reading device 22, and causing the second reading device 24 capable of identifying the color information to read different information or increasing the amount of information, when using the second reading device 24. For example, the information code can be utilized as a normal monochrome barcode from which general product information can be read by using a POS terminal or the like. In addition, the information code can also be utilized as an information code capable of providing more detailed product information, when being read by a camera device or the like installed in a mobile phone.

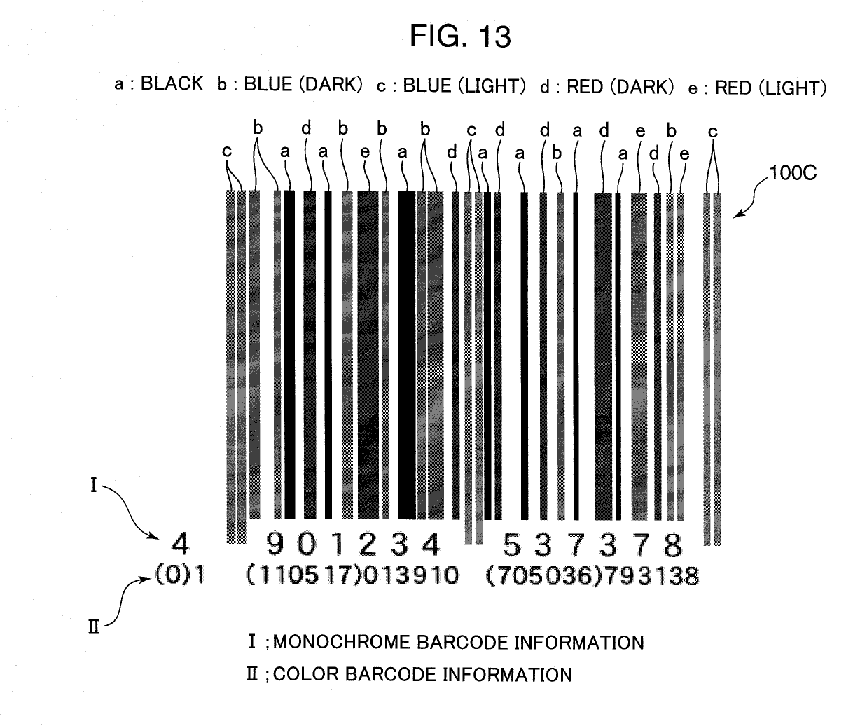

FIGS. 13 to 15 show specific examples of information codes to which the present invention is applied. FIG. 13 is a planar view showing a one-dimensional code type information code 100C. FIG. 13 shows an example of the information code 100C, which is a one-dimensional barcode in which bars representing display regions are arranged one-dimensionally, wherein each bar is configured by black, blue (dark), blue (light), red (dark), red (light) and white. When this information code 100C is read by the first reading device 22, black, blue (dark) and blue (light) are read as “black”, and white, red (dark) and red (light) are read as “white.” When the information code 100C is read by the second reading device 24, blue (dark), blue (light), red (dark) and red (light) are identified and read.

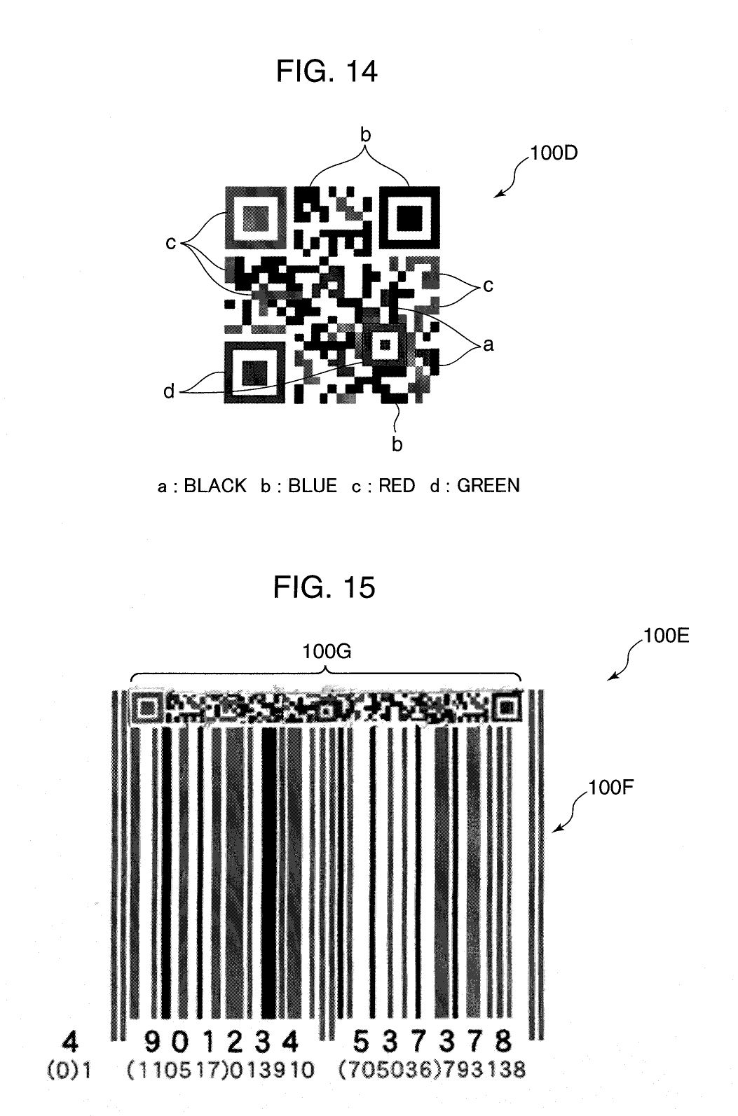

FIG. 14 is a planar view showing a two-dimensional code type information code 100D. The information code 100D, which is so-called QR Code™, is a two-dimensional barcode in which each display region is expressed by a two-dimensionally arranged unit cells. The unit cells of the information code 100D include black, blue, red and green, and two-dimensional information is described with these unit cells. When the information code 100D is read by the first reading device 22, black and blue are read as “black,” and white, red and green are read as “white.” When the information code 100D is read by the second reading device 24, blue, red and green are identified and read.

FIG. 15 is a planar view showing a combination type information code 100E. The information code 100E is obtained by combining the one-dimensional code with the two-dimensional code, and includes a one-dimensional code type information code part 100F (substantially the same as the information code 100C) and a two-dimensional code type information code part 100G (obtained by opening the information code 100D into a rectangle), which are illustrated above.

In the combination type information code 100E, the following four combinations are realized depending on whether the information code part 100F and the information code 100G are handled as a monochrome information code or a color information code.

Information code part 100F×Information code part 100G=

(a) Monochrome×monochrome

(b) Monochrome×color

(c) Color×monochrome

(d) Color×color

According to the information code 100E, not only is it possible to associate the one-dimensional code information with the two-dimensional code information, but also the abovementioned combination of (a) to (d) can be realized. Therefore, both of the code information can be associated regardless of whether the bars or cells are colored. Moreover, by using the second reading device 24 to read the information code, different standard code information can be read at once. In addition, by making the information code of the combination type information code, the size of the part placed on a package surface can be reduced.

### Other Modifications

The above has described various embodiments of the present invention, but the present invention is not limited thereto, and therefore the following modifications can be adopted.

(1) The embodiments above have illustrated the one-dimensional barcode as the information code, in which the display regions are expressed as bars that are arranged one-dimensionally. However, the present invention can be applied to a two-dimensional code, such as QR Code™.

(2) The embodiments above have described that the first reading device 22 takes a module color, which has the color information but is recognized as “white,” as “red”, and a module color, which has the color information but is recognized as “black,” as “blue”. These colors are merely examples, and the modules colors can be set to other colors in accordance with the reflectance with respect to the light source adopted for the first reading means.

(3) The embodiments above have described a case in which the information code are read by the first reading device 22 that functions as the first reading means and is configured by a barcode reader having the red LED as a light source. Generally, line light of a red single-color light source is used as a barcode reader, but, for example, a reading device that radiates a green aiming beam in spots and receives the reflected light therefrom may be used.

(4) The embodiments above have illustrated a camera device of a mobile phone as the second reading means, but various other electronic devices having imaging functions can be applied. Furthermore, when a wide variety of color modules having different tones are included in the information code, it is desired that an imaging device with a spectrocolorimetric function be used so that the difference between the colors can be identified accurately.

Alternatively, a reading device functioning as a barcode reader without an imaging function can be used as the second reading device. In this case, as light sources, a plurality of LEDs with different emission wavelengths are provided to a reading head, and the reflected light levels for color modules having different density gradations are obtained previously with respect to the light beams from the LEDs, to set a determination threshold values. For example, when using LEDs having emission wavelengths of λd, λ2, λ3, the color modules 1, 2 and 3 have a large reflectance for the emission wavelengths λd, λ2 and λ3 respectively, and a threshold value corresponding to each reflectance is set so that the color information can be identified.

Note that the specific embodiments described above mainly include inventions with the following configurations.

A color gradation information code according to one aspect of the present invention is an information code that corresponds to first reading means for performing white or black binarization determination on reflected light and reading region information, and to second reading means for identifying color information of the reflected light and reading the region information, the information code including a first display region that is determined to be black or white by both the first reading means and the second reading means, and a second display region that is determined to be white or black by the first reading means and identified as the color information by the second reading means.

According to this configuration, when the information code is read by the first reading means the region information of the first display region and second display region are read as black or white, but when the information code is read by the second reading means, the region information of the second display region can be read as the color information. Therefore, although the same information code is used, different information can be read in accordance with the reading means.

The color gradation information code according to another aspect of the present invention is an information code that corresponds to first reading means for performing white or black binarization determination on reflected light and reading region information, and to second reading means for identifying color information of the reflected light and reading the region information, the information code including a third display region that is determined to be black by both the first reading means and the second reading means, a fourth display region that is determined to be white by both the first reading means and the second reading means, and a fifth display region that is determined to be white by the first reading means and identified as the color information by the second reading means.

According to this configuration, when the information code is read by the first reading means the region information of the third display region is read as “black,” and the region information of the fourth region and fifth region are read as “white,” whereby arrangement information with black and white can be read. On the other hand, when the information code is read by the second reading means, the region information of the third display region and fourth display region are read as “black” and “white” as with the first reading means, but the region information of the fifth display region can be read as the color information. Therefore, although the same information code is used, the amount of information can be increased in accordance with the reading means.

The color gradation information code according to yet another aspect of the present invention is an information code that corresponds to first reading means for performing white or black binarization determination on reflected light and reading region information, and second reading means for identifying color information of the reflected light and reading the region information, the information code including a sixth display region that is determined to be black by both the first reading means and the second reading means, a seventh display region that is determined to be white by both the first reading means and the second reading means, and an eighth display region that is determined to be black by the first reading means and identified as the color information by the second reading means.

According to this configuration, when the information code is read by the first reading means the region information of the sixth and eighth display regions are read as “black,” and the region information of the seventh region is read as “white,” whereby arrangement information with black and white can be read. On the other hand, when the information code is read by the second reading means, the region information of the sixth display region and seventh display region are read as “black” and “white” as with the first reading means, but the region information of the eighth display region can be read as the color information. Therefore, although the same information code is used, the amount of information can be increased in accordance with the reading means.

In the configuration described above, it is desired that the information code be provided with the second display region, the fifth display region, or the eighth display region in plurality, and that the color of one of the display regions and the color of another one of the display regions have the same or similar hue, and have differences in brightness and/or saturation.

According to this configuration, because the information code includes a plurality of color information having different brightness and/or saturations, the amount of information can further be increased.

The color gradation information code according to yet another aspect of the present invention is an information code that corresponds to first reading means for performing white or black binarization determination on reflected light and reading region information, and to second reading means for identifying color information of the reflected light and reading the region information, the information code including: a first information layer, which is configured by a white-designated region and black-designated region and information of which is read by the first reading means; and a second information layer, which is configured by a first color region that is written over the white-designated region and that is determined to be white by the first reading means, and identified as first color information by the second reading means, and a second color region that is written over the black-designated region and that is determined to be black by the first reading means, and identified as second color information by the second reading means, and information in the second information layer being read by the second reading means.

According to this configuration, when the information code is read by the first reading means, the information of the first information layer can be read without any influences of the presence of the second information layer. When, on the other hand, the information code is read by the second reading means, the color information of the second information layer can be read. Therefore, although the same information code is used, different information can be read in accordance with the reading means.

In this case, desirably, the second information layer has: a third color region, which is written over the white-designated region and that is determined to be white by the first reading means, and identified by the second reading means as third color information that differs from the first color information; and a fourth color region, which is written over the black-designated region and that is determined to be black by the first reading means, and identified by the second reading means as fourth color information that differs from the second color information, the first color region and the third color region being disposed on the white-designated region so as not to substantially overlap on each other, and the second color region and the fourth color region being disposed on the black-designated region so as not to substantially overlap on each other.

This configuration can provide a color gradation information code suitable for use in a decimalization process in which the first color information and second color information of the second information layer are handled as a color signal “1,” and the third color information and fourth color information of a third information layer are handled as a colored signal “2.”

Moreover, it is desired that the information code further include a third information layer, which is configured by a third color region that is written over the white-designated region and that is determined to be white by the first reading means, and identified by the second reading means as the third color information that differs from the first color information, and a fourth color region that is written over the black-designated region and that is determined to be black by the first reading means, and identified by the second reading means as the fourth color information that differs from the second color information, information in the third information layer being read by the second reading means.

According to this configuration, because the third information layer including the color information is further overwritten, the amount of information can further be increased.

In this case, the information code can include a section in which the first color region and the third color region substantially overlap on each other on the white-designated region, and/or the second color region and the fourth color region substantially overlap on each other on the black-designated region. This configuration can provide a color gradation information code that is suitable for use in a process in which the first information layer, the second information layer and the third information layer are handled as information layers that are completely independent of one another.

Any one of the configurations described above is one of the modes in which the information code is desirably a one-dimensional barcode where the display regions are expressed as bars that are arranged one-dimensionally. According to this configuration, the amount of information existing in a general one-dimensional barcode can be increased without particularly changing the distribution pattern of the one-dimensional barcode.

The configuration mentioned above is one of the modes in which the information code is desirably a two-dimensional barcode in which the display regions are expressed by a two-dimensional arrangement of unit cells. According to this configuration, the amount of information existing in a general two-dimensional barcode such as QR Code™ can be increased without particularly changing the distribution pattern of the two-dimensional barcode.

The configuration mentioned above is one of the modes in which the information code is desirably configured by a combination of a one-dimensional barcode in which the display regions are expressed as bars that are arranged one-dimensionally, and a two-dimensional barcode in which the display regions are expressed by a two-dimensional arrangement of unit cells.

1. A color gradation information code, which corresponds to first reading device for performing white or black binarization determination on reflected light and reading region information, and to second reading device for identifying color information of the reflected light and reading the region information,
the information code comprising:
a first display region that is determined to be black or white by both the first reading device and the second reading device; and
a second display region that is determined to be white or black by the first reading device and identified as the color information by the second reading device.

2. A color gradation information code, which corresponds to first reading device for performing white or black binarization determination on reflected light and reading region information, and to second reading device for identifying color information of the reflected light and reading the region information,
the information code comprising:
a third display region that is determined to be black by both the first reading device and the second reading device;
a fourth display region that is determined to be white by both the first reading device and the second reading device; and
a fifth display region that is determined to be white by the first reading device and identified as the color information by the second reading device.

3. A color gradation information code, which corresponds to first reading device for performing white or black binarization determination on reflected light and reading region information, and to second reading device for identifying color information of the reflected light and reading the region information,
the information code comprising:
a sixth display region that is determined to be black by both the first reading device and the second reading device;
a seventh display region that is determined to be white by both the first reading device and the second reading device; and
an eighth display region that is determined to be black by the first reading device and identified as the color information by the second reading device.

4. The color gradation information code according to claim 1, wherein the information code is provided with the second display region in plurality, and the color of one of the display regions and the color of another one of the display regions have the same or similar hue, and have differences in at least one of brightness and saturation.

5. A color gradation information code, which corresponds to first reading device for performing white or black binarization determination on reflected light and reading region information, and to second reading device for identifying color information of the reflected light and reading the region information,
the information code comprising:
a first information layer, which is configured by a white-designated region and black-designated region and information of which is read by the first reading device; and
a second information layer, which is configured by a first color region that is written over the white-designated region, and that is determined to be white by the first reading device, and identified as first color information by the second reading device, and a second color region that is written over the black-designated region and that is determined to be black by the first reading device, and identified as second color information by the second reading device, information in the second information layer being read by the second reading device.

6. The color gradation information code according to claim 5, wherein
the second information layer includes: a third color region, which is written over the white-designated region, and which is determined to be white by the first reading device, and identified by the second reading device as third color information that differs from the first color information; and a fourth color region, which is written over the black-designated region, and which is determined to be black by the first reading device, and identified by the second reading device as fourth color information that differs from the second color information,
the first color region and the third color region being disposed on the white-designated region so as not to substantially overlap on each other, and the second color region and the fourth color region being disposed on the black-designated region so as not to substantially overlap on each other.

7. The color gradation information code according to claim 5, further comprising a third information layer, which is configured by a third color region that is written over the white-designated region and that is determined to be white by the first reading device, and identified by the second reading device as the third color information that differs from the first color information, and a fourth color region that is written over the black-designated region and that is determined to be black by the first reading device, and identified by the second reading device as the fourth color information that differs from the second color information, information in the third information layer being read by the second reading device.

8. The color gradation information code according to claim 6, including a section in which the first color region and the third color region substantially overlap on each other on the white-designated region, and/or the second color region and the fourth color region substantially overlap on each other on the black-designated region.

9. The color gradation information code according to claim 1, wherein the information code is a one-dimensional barcode in which the display regions are expressed as bars that are arranged one-dimensionally.

10. The color gradation information code according to claim 1, wherein the information code is a two-dimensional barcode in which the display regions are expressed by a two-dimensional arrangement of unit cells.

11. The color gradation information code according to claim 1, wherein the information code is configured by a combination of a one-dimensional barcode in which the display regions are expressed as bars that are arranged one-dimensionally, and a two-dimensional barcode in which the display regions are expressed by a two-dimensional arrangement of unit cells.

12. The color gradation information code according to claim 2, wherein the information code is provided with the fifth display region in plurality, and the color of one of the display regions and the color of another one of the display regions have the same or similar hue, and have differences in brightness and/or saturation.

13. The color gradation information code according to claim 3, wherein the information code is provided with the eighth display region in plurality, and the color of one of the display regions and the color of another one of the display regions have the same or similar hue, and have differences in brightness and/or saturation.

14. The color gradation information code according to claim 5, wherein the information code is a one-dimensional barcode in which the display regions are expressed as bars that are arranged one-dimensionally.

15. The color gradation information code according to claim 5, wherein the information code is a two-dimensional barcode in which the display regions are expressed by a two-dimensional arrangement of unit cells.

16. The color gradation information code according to claim 5, wherein the information code is configured by a combination of a one-dimensional barcode in which the display regions are expressed as bars that are arranged one-dimensionally, and a two-dimensional barcode in which the display regions are expressed by a two-dimensional arrangement of unit cells.
